(19) United States
(12) Patent Application Publication
(10) Pub. No.: US 2002/0076991 A1
(43) Pub. Date: Jun. 20, 2002

(54) Electrical connector with self-adjusting contact elements

(76) Inventors: Miguel Conde, Seal Beach, CA (US); Laszlo A. Pallai, Ste Anne-de-Bellevue (CA)

Correspondence Address: Joseph W. Bain, Akerman, Senterfitt & Eidson, P.A., P.O. Box 3188, West Palm Beach, FL, 33402-3188, US

(21) Appl. No.: 10/081,530

(22) Filed: Feb. 21, 2002

Related U.S. Application Data
(63) Continuation-in-part of application No. 09/597,181, filed on Jun. 20, 2000, now abandoned.

(51) Int. Cl. H01R 9/22

(52) U.S. Cl. 439/709

(57) ABSTRACT

An electrical connector for surface mounting and solder anchoring on a circuit board. The electrical connector has a plurality of contact elements that engage respective contact pads on the circuit board. The contact elements are free to move within the body of the electrical connector such that they can spatially self-adjust in order to compensate for non-planarity of the circuit board, as well as for mismatches between the inherent properties of the different connector and circuit board materials.

### CROSS-REFERENCE TO RELATED APPLICATION

The present application is a continuation-in-part of U.S. patent application Ser. No. 09/597,181, filed Jun. 20, 2000.

### FIELD OF THE INVENTION

The invention relates to electric terminals, in particular to an electrical connector with a plurality of contact elements mounted in a body of insulating material. The electrical connector is suitable for surface mounting on a circuit board having electrical contact pads designed to receive respective contact elements. The contact elements are characterized by the ability to move in the body of insulating material, which allows them to acquire the proper relationship with the contact pads on the circuit board during surface mounting of the electrical connector onto the circuit board.

### BACKGROUND OF THE INVENTION

Traditional electrical connectors that are surface mounted and solder anchored on a circuit board have a body of insulating material that supports a plurality of contact elements. When the electrical connector is mounted on the circuit board, the contact elements rest on the respective contact pads formed on the circuit board. For a permanent connection, the electrical connectors are soldered to the respective contact pads.

During the assembly operation, the contact pads on the circuit board are coated with solder paste. Subsequently, the electrical connector is deposited on the circuit board at a position such that the contact elements register with the respective contact pads. The contact pads are then heated to cause the solder paste to melt and permanently join the contact elements to the contact pads.

Electrical connectors for surface mounting on a circuit board are typically manufactured with a high level of precision such that the contact elements are all substantially co-planar. However, manufacturing defects may result in a failure to realize this perfectly coplanar relationship. Further, within the electronic industry, circuit boards are rarely manufactured with perfectly planar surfaces. Whether the circuit board is a small, simple Printed Circuit Board (PCB) with a single layer of traces or a large, complex PCB with multiple layers of traces, non-planarity of the circuit board surface is a common problem. As a result, during the surface mounting of an electrical connector to a circuit board, one or more of the contact elements of the electrical connector are typically not in firm contact with the respective contact pads of the circuit board. This may result in faulty contact element/contact pad joints between the electrical connector and the circuit board.

To compensate for improper manufacturing tolerances, it is known to apply pressure on the electrical connector such that the body of insulating material is distorted sufficiently to bring all the contact elements in firm contact with the respective contact pads of the circuit board. The pressure between the electrical connector and the circuit board is maintained until the soldering operation is completed. However, this technique has several drawbacks. First, the application of pressure requires an additional step and necessitates additional equipment during the assembly operation, particularly if the assembly operation is fully automated. Second, after the contact element/contact pad joints have cooled, the electrical connector is likely to remain under strain, which may result in overstressed joints that are likely to fail prematurely.

Also problematic within the field of electrical connectors are the different Coefficients of Thermal Expansion (CTE) and the different temperatures for different materials. More specifically, problems arise during and after the surface mounting of an electrical connector to a circuit board due to differences between the CTEs of the electrical connector and the circuit board (also referred to as CTE mismatch), as well as due to differences between the temperatures of the electrical connector and the circuit board (also referred to as temperature gradients). These differences may cause the circuit board and the electrical connector to change dimension, through expansion or contraction, at different rates (speeds and magnitudes), which may cause additional strain or stress on the contact element/contact pad joints, thus effecting the long term reliability of the joints and of the electrical circuit.

Further, the different hygroscopic properties of different materials may also cause the circuit board and the electrical connector to expand or contract at different rates, also causing strain or stress on the contact element/contact pad joints. Many plastics, such as polyamides, are hygroscopic, which means that they are capable to absorb a certain amount of moisture. In the case of a hygroscopic electrical connector, such absorption would cause the connector to expand in relation to the circuit board, which is not typically hygroscopic in nature, thus causing stress on the contact element/contact pad joints.

Accordingly, there is a need in the industry to develop improved electrical connectors that do not require the application of pressure to be adequately surface mounted on a circuit board, and that compensate for both manufacturing defects and mismatches between the inherent properties of different structural materials.

### SUMMARY OF THE INVENTION

According to a broad aspect, the invention provides an electrical connector suitable for surface mounting to a circuit board having a plurality of electrical contact pads. The electrical connector has a body of insulating material including a circuit board facing side. A plurality of contact elements are mounted in the body of insulating material, each contact element being free to move in the body of insulating material relative to the circuit board facing side, between a plurality of different positions.

In a specific non-limiting example of implementation of the invention, the body of insulating material defines a plurality of individual cages that hold captive respective contact elements. Each cage is formed of a top wall, a bottom wall and four sidewalls. The bottom wall is provided with an aperture that opens on the circuit board facing side of the electrical connector, while at least one of the sidewalls is at least partially open to allow access to the contact element mounted in the cage. Each contact element has a contact portion and a contact element body portion. The contact portion is the part of the contact element that engages a contact pad on the circuit board when the electrical connector is mounted on it.

The cages are sized such that each contact element is free to move in several different directions, and thus between several different positions, within its respective cage.

In a first direction of movement, each contact element is free to move along a vertical direction within its cage, between two extreme positions. In the first position, the contact portion projects from the circuit board facing side. In the second position the contact portion is flush or slightly recessed relative to the circuit board facing side. During the placement of the electrical connector on the circuit board, gravity causes the contact elements to move in their respective cages such that the contact portions project from the circuit board facing side. When the electrical connector is deposited on the circuit board, the contact portions are the first components of the electrical connector to contact the circuit board. As the deposition movement continues, the body of the electrical connector descends towards the circuit board, such that the contact elements start to progressively retract in their cages, until the circuit board facing side touches the circuit board. At this point, certain contact elements may have retracted more or less than others, in dependence of the non-planarity of both the circuit board surface and the electrical connector.

Although during the deposition movement the contact elements retract inside their cages, this retraction is not the result of movement by the contact elements themselves. Rather, as the body of the electrical connector descends towards the circuit board, it is actually the cages that move down onto the contact elements.

In a second direction of movement, each contact element is free to tilt at least in part within its cage, under the effect of gravity. This tilting movement may also be considered a rotation about a horizontal axis. More specifically, the contact element is free to tilt towards or away from any one of the sidewalls of its cage, such that the contact portion is angled relative to the circuit board facing side. The dimensions of the cage determine the extreme positions between which the contact element can rotate or tilt, in each of these extreme positions the contact element body portion abutting against either a sidewall or the top wall of the cage.

When the electrical connector is deposited on the circuit board, and the contact portions contact the contact pads of the circuit board, gravity will allow the contact elements to tilt within their cages in order to compensate for non-planarity of the circuit board surface. Thus, for each contact element, the surface area of the contact portion that is in contact with the respective contact pad will be maximized.

Once the electrical connector has been deposited on the circuit board, and the contact elements have self-adjusted to engage the contact pads, heat is applied to melt the solder paste on the contact pads and thus solder anchor the contact elements to the circuit board. In third direction of movement, each contact element is free to move laterally within its cage, between each pair of parallel sidewalls forming the cage, while in a fourth direction of movement, each contact element is free to rotate about a vertical axis. Thus, during soldering of the contact elements to the circuit board, as well as during use of the electrical circuit in its final application, the contact elements can move freely during expansion or contraction of either one of, or both, the contact elements and the circuit board. This free lateral and rotational movement of the contact elements ensures that stresses (forces/pressures) or strains (stretching/compression) on the contact element/contact pad joints are minimized.

The reader will appreciate that under the above specific and non-limiting example of implementation, the floating contact elements can compensate for circuit board irregularities and defects on the circuit board or the electrical connector itself that render either one of them or both non-planar. They can also compensate for mismatches in the inherent properties of the materials of the electrical connector and the circuit board, such as CTE mismatch.

Under a second broad aspect, the invention provides an electrical connector suitable for surface mounting to a circuit board having a plurality of electrical contact pads. The electrical connector has a body of insulating material including a circuit board facing side and a plurality of contact elements mounted in the body of insulating material. Each contact element has a contact portion suitable for engaging a corresponding electrical contact pad when the electrical connector is mounted on the circuit board. Each contact element is free to move in the body of insulating material relative to the circuit board facing side between a plurality of different positions, including a first position and a second position. In the first position, the contact portion projects from the circuit board facing side. In the second position, the contact portion is recessed relative to the circuit board facing side.

Under another broad aspect, the invention provides an electrical connector suitable for surface mounting and solder anchoring to a circuit board having a plurality of electrical contact pads. The electrical connector has a body of insulating material including a circuit board facing side and a plurality of contact elements mounted in the body of insulating material. Each contact element has a contact portion suitable for engaging a corresponding electrical contact pad when the electrical connector is mounted on the circuit board, the contact portion projecting from the circuit board facing side. When the electrical connector is deposited on the circuit board, the contact portions of the contact elements engage the circuit board and are spatially adjustable at least partially relative to the circuit board facing side.

### BRIEF DESCRIPTION OF THE DRAWINGS

A detailed description of examples of implementation of the present invention is provided hereinbelow with reference to the following drawings, in which:

FIG. 1 is a perspective view from above of an electrical connector constructed in accordance with an example of implementation of the present invention;

FIG. 2 is a perspective view of the contact elements in the electrical connector shown in FIG. 1;

FIG. 3 is a perspective view from below of the electrical connector shown in FIG. 1;

FIG. 4 is a magnified fragmentary cross-sectional view of the electrical connector during surface-mounting onto a circuit board;

FIG. 5 is a magnified fragmentary cross-sectional view of the electrical connector once mounted on a circuit board;

FIG. 6 illustrates alternative examples of implementation for the contact elements of the electrical connector shown in FIG. 1; and

FIG. 7 is a perspective view from above of a variant of the electrical connector shown in FIG. 1.

In the drawings, embodiments of the invention are illustrated by way of example. It is to be expressly understood that the description and drawings are only for purposes of illustration and as an aid to understanding, and are not intended to be a definition of the limits of the invention.

### DETAILED DESCRIPTION

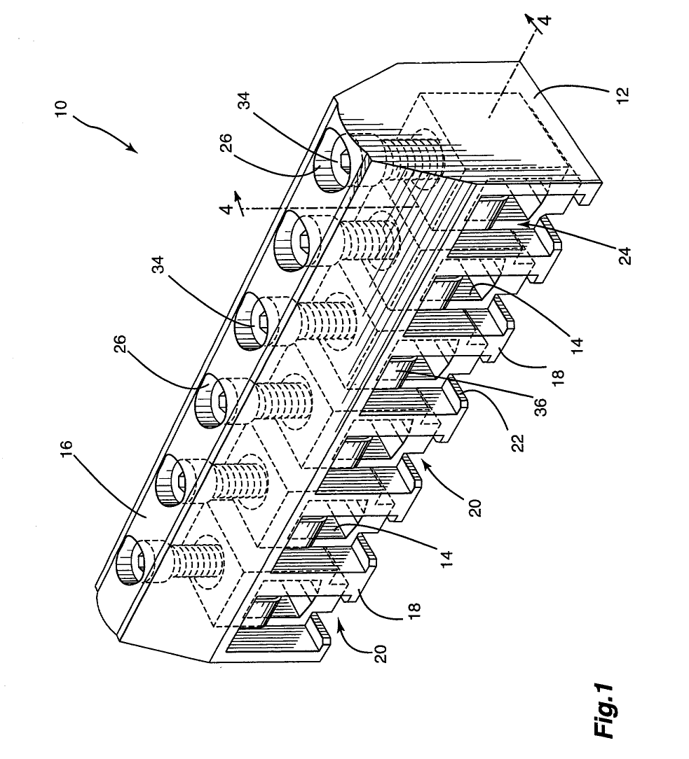

FIG. 1 illustrates an electrical connector 10 constructed in accordance with a non-limiting example of implementation of the present invention. The electrical connector 10 includes two main components, notably a body of insulating material 12 and a plurality of contact elements 14. The contact elements 14 are mounted in the body of insulating material 12.

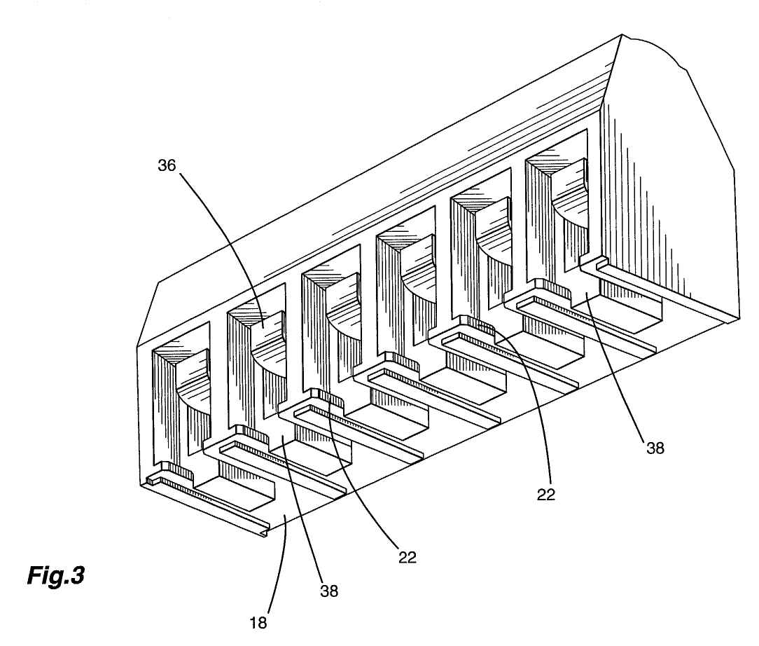

The body of insulating material 12 is made of any suitable synthetic material that has the requisite dielectric strength and mechanical resistance characteristics. The body of insulating material 12 includes a topside 16 and a bottom side 18, the latter constituting a circuit board facing side. The circuit board facing side 18, which is best shown in FIG. 3, is substantially flat.

The body of insulating material 12 defines a plurality of cages 20 designed to receive respective ones of the contact elements 14. Each cage 20 is generally rectangular in shape and includes a top wall, a bottom wall and four sidewalls. The bottom wall is provided with an aperture 22 that opens on the circuit board facing side 18. One of the sidewalls of each cage 20 is open at 24 to allow access to the contact elements 14 mounted in the cages 20. Each cage also has a cylindrical extension 26 at its top, opening on the topside 16.

Note that, in a variant example, the opening at 24 is only a partial opening of the respective sidewall of cage 20. In another variant, two opposite sidewalls of each cage 20 are open, or partially open, in order to allow access to the contact element 14 therein.

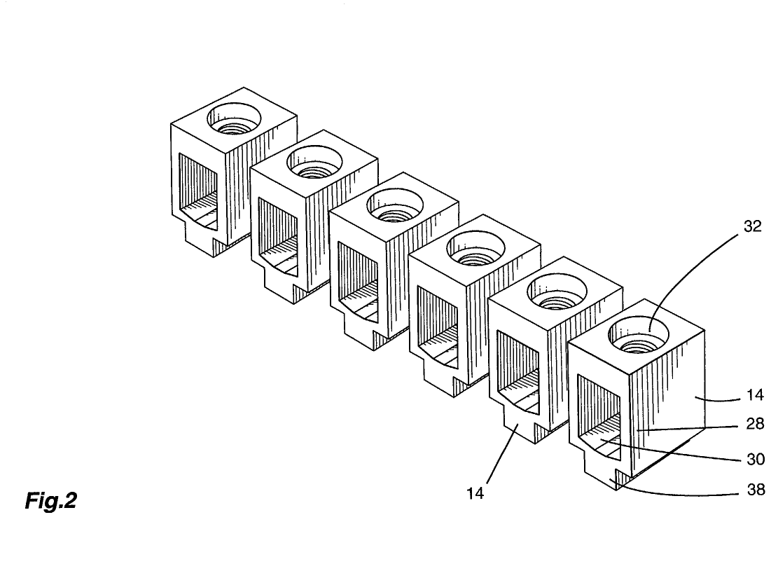

With reference to FIG. 2, each contact element 14 is made of metallic material such as brass, copper or aluminum. The contact element 14 has a contact element body portion 28 having generally a rectangular shape and defining a recess 30 in which the conductor portion of a wire (not shown in the drawings) can be inserted. The top of the contact element body portion 28 is provided with a threaded aperture 32 to receive a screw 34 (shown in FIG. 1). As it will be plain to a person skilled in the art, the screw 34 is used to secure in place the conductor of the wire inserted in the recess 30. Optionally, a L-shaped strip 36 (best shown in FIGS. 1 and 3) is placed in the recess 30 to more uniformly spread the pressure applied on the conductor of the wire by the screw 34.

Note that the threaded engagement between the screw 34 and the contact element 14 ensures that the electrical connector 10 does not dismantle (i.e. that the body 12 does not become separated from the contact elements 14), for example during transportation or vibration.

In a variant example, each cylindrical extension 26 includes a small, circular ledge at its top for preventing the screw 34 from projecting from, or falling out of, the topside 16 of the body 12.

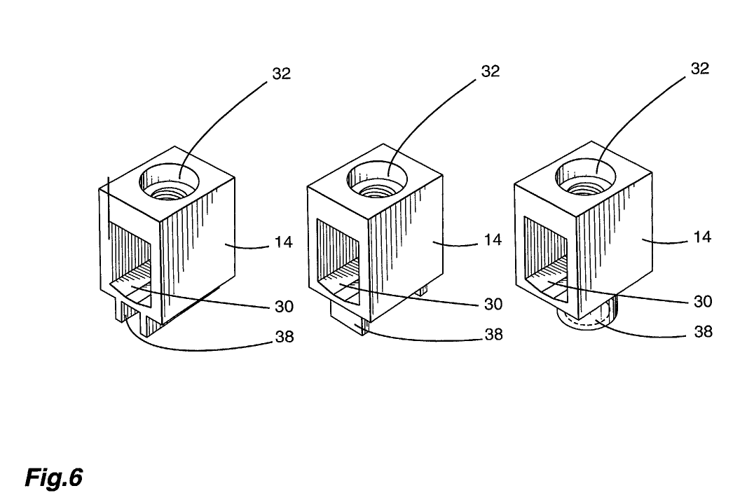

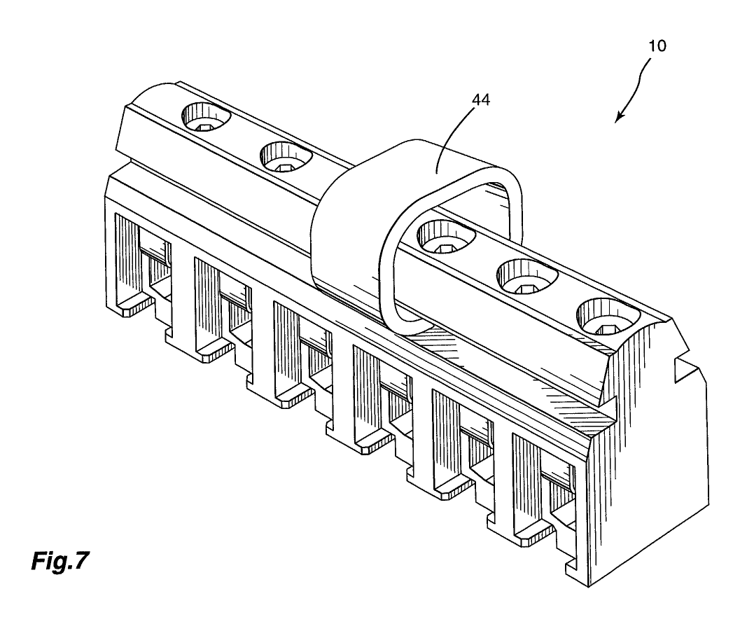

From the contact element body portion 28 projects downwardly a contact portion 38. In this example, the contact portion 38 extends the entire length of the contact element but it has a transverse dimension that is reduced relative to the transverse dimension of the contact element 14. Note however that the contact portion 38 is not limited to any one particular shape or dimension. Rather, the contact portion 38 may assume various shapes and dimensions, a few examples of which are shown in FIG. 6.

The cages 20 receiving the contact elements 14 are dimensioned such as to allow the contact elements 14 to freely float therein, such that the contact elements 14 are movable in several different directions. Advantageously, the range of movement of the contact element 14 within the cage 20 is such as to accommodate possible co-planarity variations that may arise on the circuit board 40 or among the contact elements 14 of the electrical connector 10.

In a first direction of movement, the contact elements 14 are free to move along a vertical direction within their respective cages 20. In the vertical direction, each contact element 14 can move in its respective cage 20 between two extreme positions. The first extreme position is shown in FIGS. 1 and 3, where the contact portion 38 is received in the aperture 22 and projects therefrom. The second extreme position is a position in which the contact portions 38 are generally flush or slightly recessed relative to the circuit board facing side 18, an example of which is shown in FIG. 5.

The contact elements 14 can move from one extreme position to the other in the vertical direction of movement under the effect of gravity. In the position shown in FIGS. 1, 3 and 4, the contact elements 14 engage the bottom walls of the respective cages 20 and are held in place there. It will be appreciated that the contact element body portions 28 have transverse dimensions exceeding the transverse dimensions of the apertures 22, such that only the contact portions 38, which are smaller than the apertures 22, can pass through the apertures 22.

In a second direction of movement, the contact elements 14 are also free to tilt at least in part within their respective cages 20. This tilting movement may also be considered to be a rotation about a horizontal axis. More specifically, within each cage 20, the respective contact element 14 is free to tilt under the effect of gravity towards or away from any one of the sidewalls of the cage 20, such that the contact portion 38 is angled relative to the circuit board facing side 18. Reference is made to FIG. 6, which shows an example of the tilting of a contact element 14 within its cage 20. The dimensions of the cage 20 determine the extreme positions between which the contact element 14 can rotate or tilt, in each of these extreme positions the contact element body portion 28 abutting against either a sidewall or the top wall of the cage 20.

In a third direction of movement, the contact elements 14 are also free to move laterally within their respective cages 20. More specifically, each contact element 14 is free to shift within its cage 20 from side to side, between each pair of parallel sidewalls forming the cage 20. Further, in a fourth direction of movement, the contact elements 14 are free to rotate within the cage 20 about a vertical axis. These third and fourth directions of movement will be discussed in further detail below.

The electrical connector 10 is installed on a circuit board in the following manner. The electrical connector 10 is picked-up by automated equipment and deposited on the circuit board, which is typically characterized by a non-planar surface, such that the contact portions 38 of the contact elements 14 register with respective contact pads on the circuit board. Before the contact portions 38 touch the contact pads, they are extended, as shown in FIG. 1. In other words, the contact portions 38 project from the circuit board facing side 18. When the contact portions 38 touch the contact pads on the circuit board, the contact portions 38 start to retract under the effect of the weight of the electrical connector 10 and also under the effect of the slight pressure created by the automated equipment that handles the electrical connector 10. The contact portions 38 continue retracting until the circuit board facing side 18 engages the circuit board surface, at which point certain contact portions 38 may have retracted more or less than others, in dependence of the non-planarity of both the circuit board surface and the electrical connector 10.

Note that during the deposition movement, once the contact portions 38 have touched the contact pads on the circuit board, the retraction of the contact portions 38 inside the electrical connector 10 is not the result of movement by the contact portions 38 themselves. Rather, the retraction of the contact portions 38 is a result of the movement of the body of the electrical connector 10 as it is deposited onto the circuit board.

During deposit of the electrical connector 10 on the circuit board, the contact portions 38 of the contact elements 14 may also tilt under the effect of gravity within their cages, in order to properly engage the contact pads on the non-planar circuit board surface.

Thus, the free movement of the contact elements 14 within the cages 20 serves to compensate for non-planarity of the surface of the circuit board as well as of the electrical connector itself. Further, the free movement of the contact elements 14 allows each contact element 14 to spatially self-adjust in order to maximize the surface area of the contact portion 38 that is in contact with the respective contact pad on the circuit board.

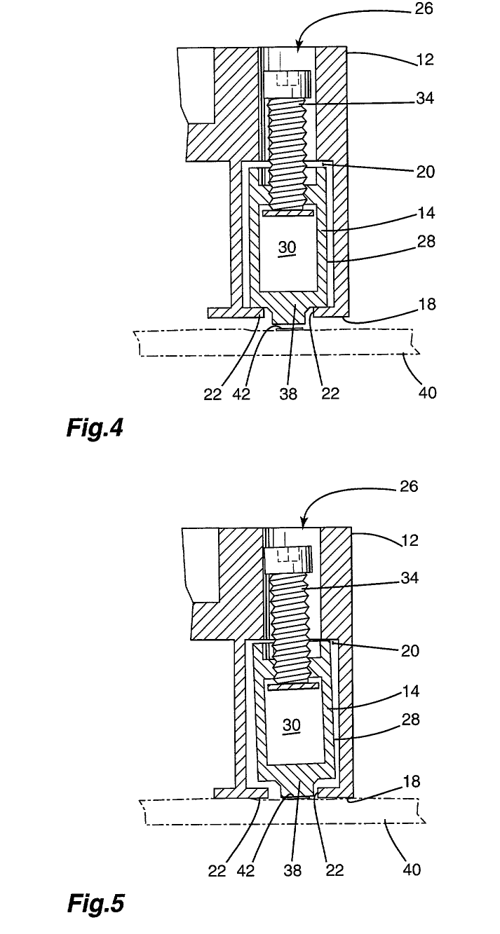

An example of the position of a contact element 14 during the deposit of electrical connector 10 onto a circuit board 40 is shown in FIGS. 4 and 5. The circuit board 40 carries on its upper surface a contact pad 42 for engagement by the contact portion 38 of the contact element 14. The contact pad 42 is coated with solder paste. During the deposit, the contact portion 38 moves from a position that is completely extended relative to the circuit board facing side 18 to a position in which the contact portion 38 has retracted partially into the cage 20 and is tilted relative to the circuit board facing side 18.

Note that in a situation where the contact pad 42 slightly projects above the surface of the circuit board 40, the contact portion 38 may even be slightly recessed relative to the circuit board facing side 18, if the contact pad 42 fits within the boundary of the aperture 22.

Once the electrical connector 10 has been deposited onto the circuit board 40, and the contact elements 14 have all self-adjusted to engage the contact pads 42, heat is applied to solder anchor the electrical connector 10 to the circuit board 40. The solder paste on the contact pads 42 melts and effects a permanent joint between the contact pads 42 and the respective contact elements 14.

After the installation of the electrical connector 10 on the circuit board 40 is completed, the conductors of wires are inserted in the respective contact elements 14. The screws 34 are then tightened by inserting a screwdriver or any other suitable tool in the cylindrical bores 26, to engage and then turn the screws 34.

During soldering of the electrical connector 10 to the circuit board 40, as well as during use of the electrical circuit in its final application, linear changes in dimensions may arise between the circuit board 40 and the contact elements 14, due to the expansion/contraction of the materials of the electrical connector 10 and of the materials of the circuit board 40. This expansion/contraction of the materials occurs at different speeds and magnitudes, due to for example different CTEs, different temperature gradients or different hygroscopic properties of the materials.

Advantageously, the contact elements 14 can move freely during expansion or contraction of either one of, or both, the electrical connector 10 and the circuit board 40. More specifically, the free lateral movement, as well as the free rotational movement about a vertical axis, of the contact elements 14 within their respective cages 20 compensate for the linear changes in dimensions that may arise. This compensation through freedom of movement ensures that stresses (forces/pressures) or strains (stretching/compression) on the joints between contact elements 14 and contact pads 42 are minimized.

It is not essential that the circuit board facing side 18 engage the circuit board 40. It is possible to design the electrical connector 10 such that the contact portions 38 project from the circuit board facing side 18 and after the electrical connector 10 has been placed on the circuit board 40 the contact portions 38 retract only partially in the body 12. In this position, the electrical connector 10 will have descended onto the circuit board 40 such that circuit board facing side 18 remains at a certain distance from the circuit board 40.

In another possible variant, the cages 20 are dimensioned such as to limit the free movement of the contact elements 14 within the cages 20 to only one or a subset of the directions of movement described above. For example, the cages 20 may be sized to allow the contact elements 14 free movement in the vertical direction only. Alternatively, the cages 20 may be sized to allow the contact elements 14 free movement in the vertical and lateral directions only, with no rotational movement possible.

In yet another possible variant, the electrical connector 10 is provided with a removable gripping handle 44 as shown in the example of FIG. 7, by which the automated equipment can more easily pick-up, transport and generally handle the electrical connector 10 during installation of the electrical connector on the circuit board 40. The gripping handle 44 may be removed once the electrical connector 10 has been soldered to the circuit board 40.

Although various embodiments have been illustrated, this was for the purpose of describing, but not limiting, the invention. Various modifications will become apparent to those skilled in the art and are within the scope of this invention, which is defined more particularly by the attached claims.

1. An electrical connector suitable for surface mounting to a circuit board having a plurality of electrical contact pads, said electrical connector comprising:
a) a body of insulating material including a circuit board facing side;
b) a plurality of contact elements mounted in said body, each contact element being free to move in said body relative to said circuit board facing side between a plurality of different positions.

2. An electrical connector as defined in claim 1, wherein said board facing side is generally planar.

3. An electrical connector as defined in claim 2, wherein each contact element includes a contact portion suitable for engaging a corresponding electrical contact pad when said electrical connector is mounted on the circuit board, each contact element being movable in said body under the effect of gravity to acquire a position in which the respective contact portion projects from said circuit board facing side.

4. An electrical connector as defined in claim 3, wherein during placement of said electrical connector on the circuit board, said contact elements are operative to spatially self-adjust when the contact portions of said contact elements engage the electrical contact pads.

5. An electrical connector as defined in claim 4, wherein the spatial self-adjustment includes a vertical movement of said contact elements within said body.

6. An electrical connector as defined in claim 5, wherein the spatial self-adjustment includes a tilting movement of said contact elements within said body.

7. An electrical connector as defined in claim 5, wherein the spatial self-adjustment includes a lateral movement of said contact elements within said body.

8. An electrical connector as defined in claim 5, wherein the spatial self-adjustment includes a rotational movement of said contact elements within said body.

9. An electrical connector as defined in claim 5, wherein, during placement of said electrical connector on the circuit board, said contact elements are operative to progressively retract in said body.

10. An electrical connector as defined in claim 4, wherein said body defines an individual cage for holding each contact element, said cage having a geometrical configuration allowing the respective contact element to move therein freely.

11. An electrical connector as defined in claim 10, wherein said cage allows the respective contact element to move in a plurality of different directions of movement.

12. An electrical connector as defined in claim 11, wherein said plurality of different directions of movement are selected from the group consisting of vertical movement, tilting movement, lateral movement and rotational movement.

13. An electrical connector as defined in claim 10, wherein each cage includes an aperture that opens on said circuit board facing side.

14. An electrical connector as defined in claim 13, wherein each contact element includes a contact element body portion from which projects the contact portion of the contact element, the aperture of the cage receiving the contact element, the contact portion of the contact element having relative dimensions allowing the contact portion to pass through the aperture.

15. An electrical connector as defined in claim 14, wherein the contact element body portion has a transverse dimension exceeding a transverse dimension of the aperture such that the contact element body portion is unable to pass through the aperture.

16. An electrical connector as defined in claim 10, wherein each contact element includes a recess for receiving a conductor of a wire.

17. An electrical connector as defined in claim 16, wherein each contact element has a screw for fastening the conductor of the wire to the contact element.

18. An electrical connector as defined in claim 17, wherein each individual cage of said body of insulating material includes a generally circular bore that receives the screw of a respective contact element.

19. An electrical connector as defined in claim 1, wherein said contact elements are disposed along an imaginary straight line.

20. An electrical connector suitable for surface mounting to a circuit board having a plurality of electrical contact pads, said electrical connector comprising:
a) a body of insulating material including a circuit board facing side;
b) a plurality of contact elements mounted in said body, each contact element including a contact portion suitable for engaging a corresponding electrical contact pad when said electrical connector is mounted on the circuit board, each contact element being free to move in said body relative to said circuit board facing side between a plurality of different positions including a first position and a second position, in the first position the contact portion projecting from said circuit board facing side, in the second position the contact portion being recessed relative to said circuit board facing side.

21. An electrical connector suitable for surface mounting and solder anchoring to a circuit board having a plurality of electrical contact pads, said electrical connector comprising:
a) a body of insulating material including a circuit board facing side;
b) a plurality of contact elements mounted in said body, each contact element including a contact portion suitable for engaging a corresponding electrical contact pad when said electrical connector is mounted on the circuit board, each contact element being movable in said body relative to said circuit board facing side between a plurality of different positions whereby, when said electrical connector is deposited on the circuit board the contact portions of said contact elements engage the contact pads of the circuit board, said contact elements being operative to spatially self-adjust at least partially relative to said circuit board facing side when the contact portions of said contact elements engage the electrical contact pads.

22. An electrical connector as defined in claim 21, wherein the spatial self-adjustment includes a vertical movement of said contact elements within said body.

23. An electrical connector as defined in claim 22, wherein the spatial self-adjustment includes a tilting movement of said contact elements within said body.

24. An electrical connector as defined in claim 22, wherein the spatial self-adjustment includes a lateral movement of said contact elements within said body.

25. An electrical connector as defined in claim 22, wherein the spatial self-adjustment includes a rotational movement of said contact elements within said body.

26. An electrical connector as defined in claim 22, wherein said plurality of different positions includes a first position and a second position, in the second position the contact portion of each contact element projecting relative to said circuit board facing side to a greater degree than in the first position.

27. An electrical connector as defined in claim 26, wherein when said electrical connector is deposited on the circuit board, said contact elements are retractable at least partially relative to said circuit board facing side.

28. An electrical connector as defined in claim 23, wherein when said electrical connector is deposited on the circuit board, said contact elements are tiltable at least partially relative to said circuit board facing side.

29. An electrical connector as defined in claim 21, wherein said circuit board facing side is generally planar.

30. An electrical connector as defined in claim 22, wherein each contact element is movable in said body relative to said circuit board facing side between a position A and a position B, in said position B each contact element projecting relative to said circuit board facing side to a greater degree than in said position A.

31. An electrical connector as defined in claim 22, wherein during placement of said electrical connector on the circuit board, the contact portions of said contact elements are operative to engage the electrical contact pads and then progressively retract in said body until said circuit board facing side contacts the circuit board.

32. An electrical connector as defined in claim 21, wherein said body defines an individual cage for holding each contact element, said cage having a geometrical configuration allowing the respective contact element to move therein.

33. An electrical connector as defined in claim 32, wherein each cage includes an aperture that opens on said circuit board facing side.

34. An electrical connector as defined in claim 33, wherein each contact element includes a contact element body portion from which projects the contact portion of the contact element, the aperture of the cage receiving the contact element, the contact portion of the contact element having relative dimensions allowing the contact portion to pass through the aperture.

35. An electrical connector as defined in claim 34, wherein the contact element body portion has a transverse dimension exceeding a transverse dimension of the aperture such that the contact element body portion is unable to pass through the aperture.

36. An electrical connector as defined in claim 32, wherein each contact element includes a recess for receiving a conductor of a wire.

37. An electrical connector as defined in claim 36, wherein each contact element has a screw for fastening the conductor of the wire to the contact element.

38. An electrical connector as defined in claim 37, wherein each individual cage of said body of insulating material includes a generally circular bore that receives the screw of a respective contact element.

39. An electrical connector as defined in claim 21, wherein said contact elements are disposed along an imaginary straight line.
